(19) United States
(12) Patent Application Publication
(10) Pub. No.: US 2015/0128668 A1
(43) Pub. Date: May 14, 2015

(54) FIREARM LOCKING DEVICE

(71) Applicant: D. Jeffrey MEREDITH, Troy, OH (US)

(72) Inventor: D. Jeffrey MEREDITH, Troy, OH (US)

(21) Appl. No.: 14/539,748

(22) Filed: Nov. 12, 2014

Related U.S. Application Data
(60) Provisional application No. 61/903,872, filed on Nov. 13, 2013.

(51) Int. Cl. F41A 17/54; G07C 9/00; E05B 73/00

(52) U.S. Cl. CPC F41A 17/54; E05B 73/00; G07C 9/00563
USPC 70/266

(57) ABSTRACT

Presently disclosed is a locking device for a firearm that includes a longitudinally extending frame and a configurable butt support, a configurable action housing, and a barrel lock. The configurable butt support defines an opening for receiving a butt of the firearm, with one or more of the width, length or base of the opening being configurable. The configurable action housing defines a channel between interchangeable opposing profiles, which are associated with the configuration of one or more firearms and inhibit access to at least a trigger of the firearm. The barrel lock is configured to secure the barrel of the firearm when in a locked position, and to release the barrel of the firearm when in an unlocked position. The locking device may also include a biometrically activated lock, such as a fingerprint reader, and a communication interface to provide information about attempts to access the firearm.

### CROSS-REFERENCE TO RELATED APPLICATION

This application is a non-provisional of and claims priority to U.S. Application 61/903,872, filed Nov. 13, 2013, the disclosure of which is incorporated here by reference.

### BACKGROUND AND SUMMARY

The present disclosure relates to devices for securing firearms, and more particularly to locking devices that are configurable for use with a variety of different firearms.

Controlling access to firearms to authorized users has long been known as a central component of firearm safety, particularly when firearms are to be stored in a home or business setting. A variety of devices have been developed to achieve this purpose. One type of device, commonly referred to as a trigger lock, affixes to the trigger of the firearm to prevent activation of the trigger while leaving the rest of the firearm unprotected. With some such devices, even with the lock installed, ammunition may still be removed or inserted. Other devices, such as safes, completely surround the firearm often hiding the firearm from sight, but also slowing access to the firearm when needed. One prior storage device for a firearm is disclosed in U.S. Pat. No. 7,200,965 and discloses a housing in which an end cap and cover plates are moveable along a spine. Although the housing may be adjusted to accommodate guns of different length, the end caps and cover plates are not configurable to properly secure different types of guns having different profiles, or even the same type of gun with different accessories. As a result, the security of the firearm and access to the operable components is less restricted than may be desired.

Therefore, there remains a need for a locking device that is configurable to accommodate a variety of different firearms while appropriately inhibiting access to the operable components of each firearm once the locking device is properly configured. There is also a need for a locking device that maintains ready access to the firearm while still inhibiting access to the operable components.

Presently disclosed is a locking device for a firearm. In embodiments, the locking device for a firearm may include a longitudinally extending frame, the frame having at least one channel configured to receive a plurality of fasteners; a configurable butt support secured to the frame by at least one of the plurality of fasteners, the butt support defining an opening for receiving a butt of the firearm, the opening having at least one of a configurable width, a configurable length, or a configurable base; a configurable action housing secured to the frame by at least one of the plurality of fasteners, the action housing defining a channel between interchangeable opposing profiles, wherein the profiles are associated with the configuration of one or more firearms and inhibit access to at least a trigger of the firearm; and a barrel lock secured to the frame by at least one of the plurality of fasteners and configured to secure the barrel of the firearm when in a locked position, and to release the barrel of the firearm when in an unlocked position; wherein when a firearm is secured in the locking device access to the plurality of fasteners is prevented.

In some embodiments, the plurality of fasteners are continuously adjustable within the channel along a length of the frame.

In some embodiments, the butt support is adapted to support the butt of the firearm such that the barrel of the firearm rests substantially parallel to the frame.

In some embodiments, the opening of the butt support defines a configurable base upon which the bottom of the butt of the firearm rests, the base being at a configurable position relative to the frame corresponding to a configuration of the butt and stock of the firearm.

In some embodiments, when the barrel lock is in a locked position, removal of the firearm from the locking device is inhibited by the lock and the butt support.

In some embodiments, the configurable butt support further includes an outer shell securable to the frame and a plurality of configurable spacers disposed with the outer shell, wherein the plurality of spacers are configurable to define at least one of the width, the length and the base of the opening.

In some embodiments, after the butt support is secured to the frame, the width, length and base of the opening are fixed.

In some embodiments, the interchangeable opposing profiles inhibit removal of ammunition from the firearm.

In some embodiments, the interchangeable opposing profiles are associated with the configuration of at least two firearms.

In some embodiments, the configurable housing further includes side portions extending perpendicular to the frame, and wherein the interchangeable opposing portions are disposed on interior surfaces of the side portions.

In some embodiments, the interchangeable opposing portions are not removable from the housing when a firearm is secured in the locking device.

In some embodiments, the barrel lock comprises a biometrically activated lock.

In some embodiments, the biometrically activated lock is remotely programmable to respond to different users.

### BRIEF DESCRIPTION

Reference is made to the accompanying drawings in which particular embodiments of the invention are illustrated as described in more detail in the description below, in which:

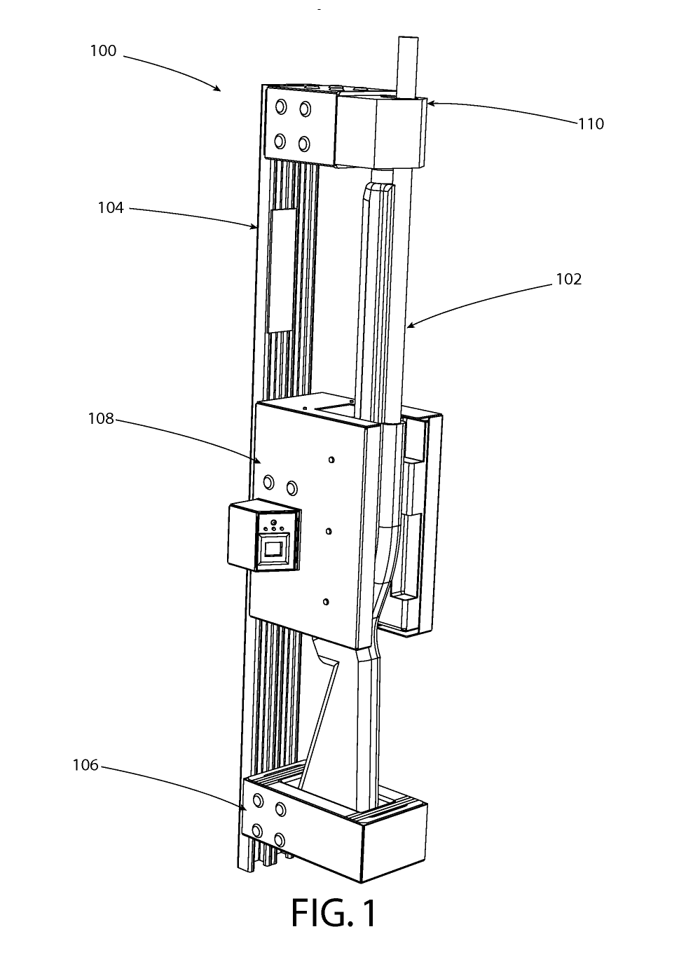

FIG. 1 is a perspective view of a locking device for a firearm;

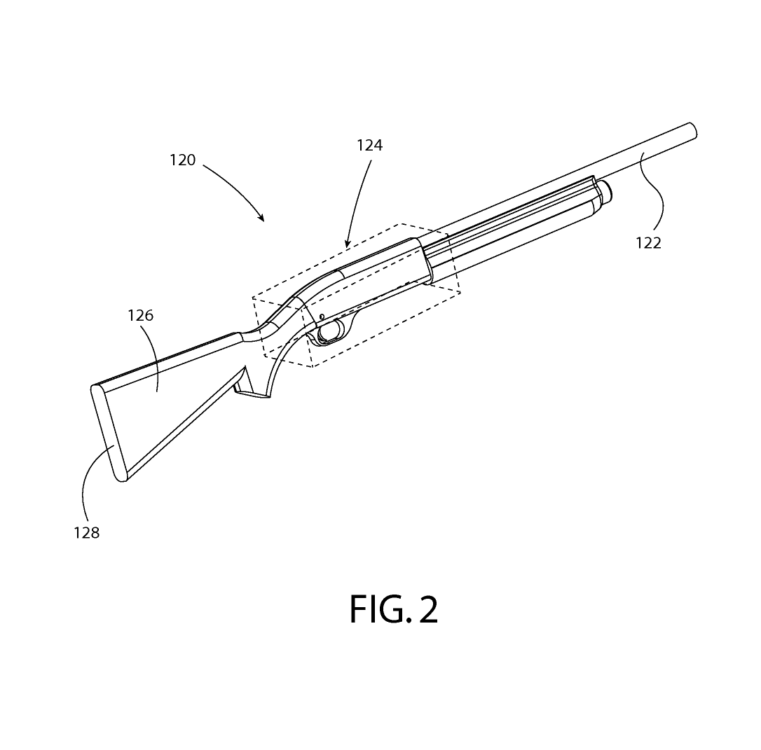

FIG. 2 is a perspective view of a long barrel firearm;

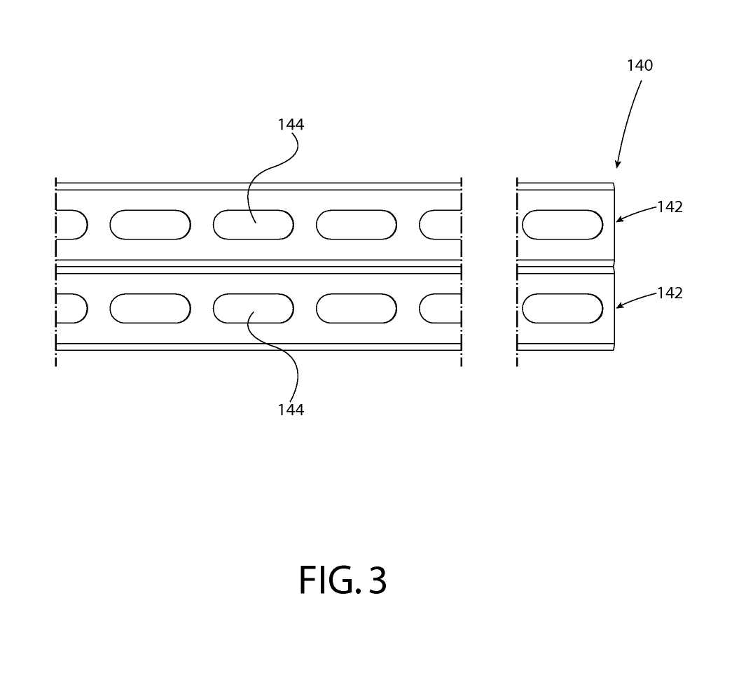

FIG. 3 is a perspective view of a longitudinally extending frame of a locking device for a firearm;

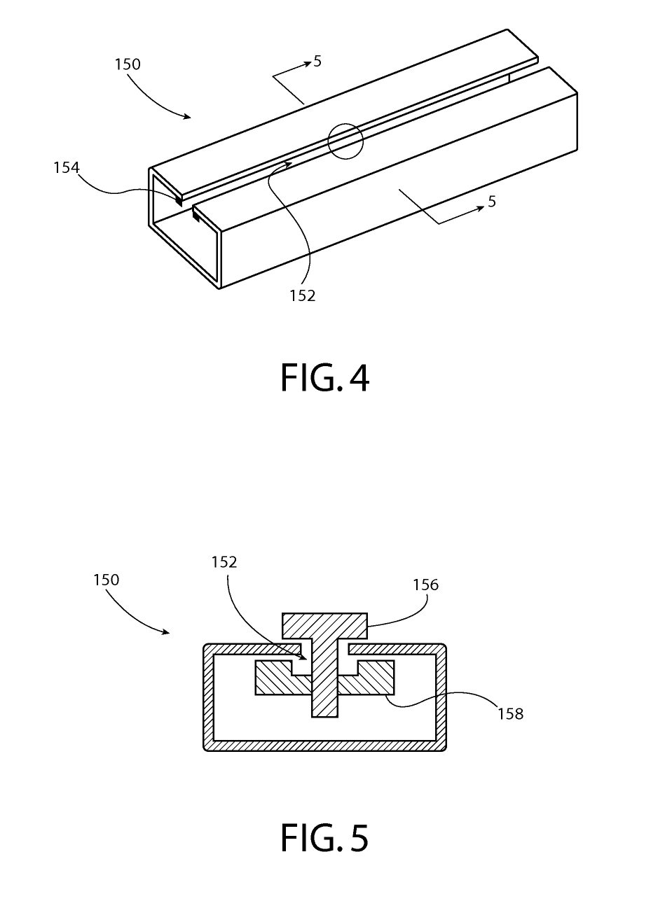

FIG. 4 is a perspective view of another longitudinally extending frame of a locking device for a firearm;

FIG. 5 is a cross-section of the longitudinally extending frame of FIG. 4 along section line 5-5;

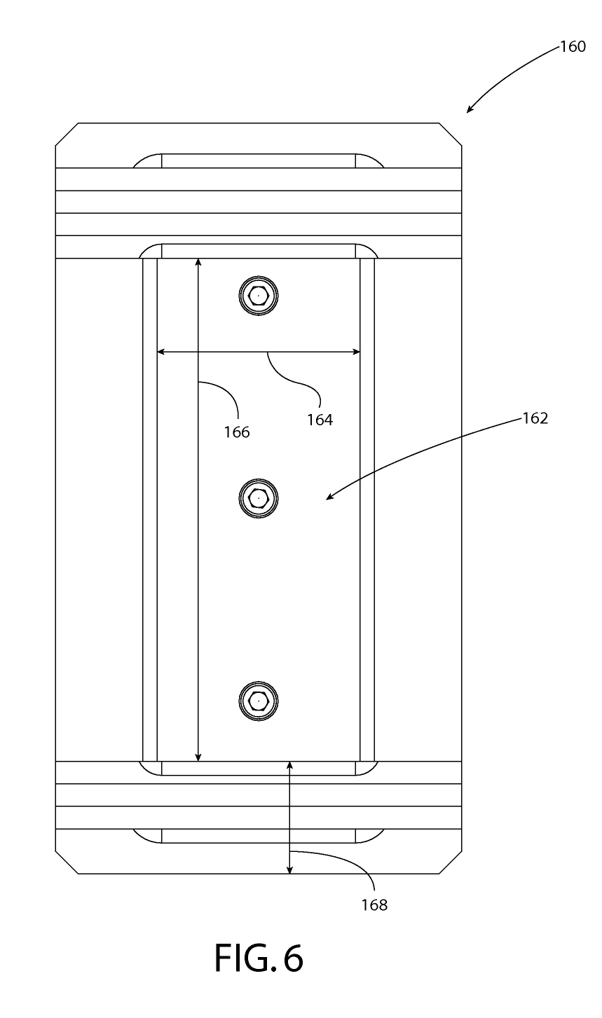

FIG. 6 is a top view of a butt support of a locking device for a firearm;

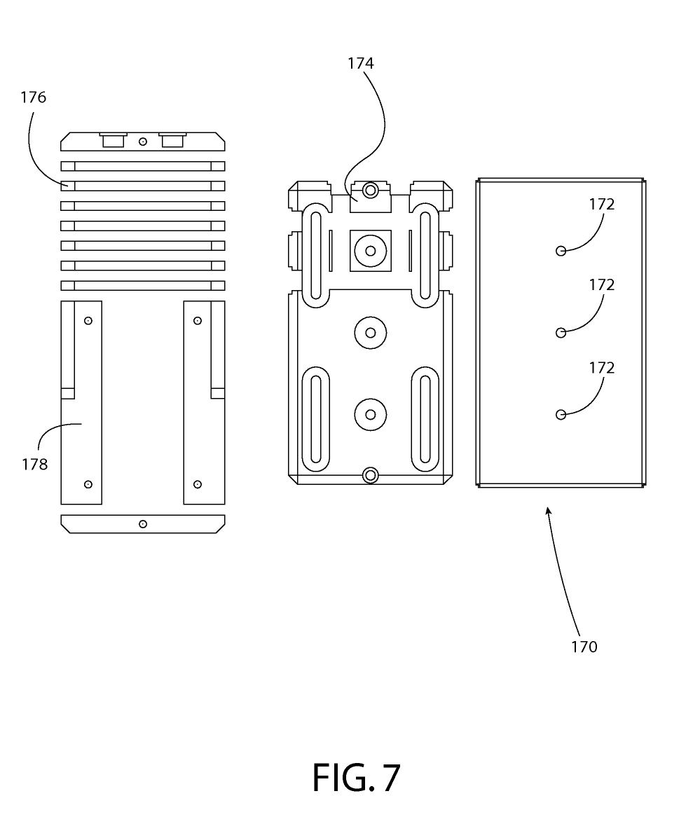

FIG. 7 is a disassembled view of a butt support having a configurable length;

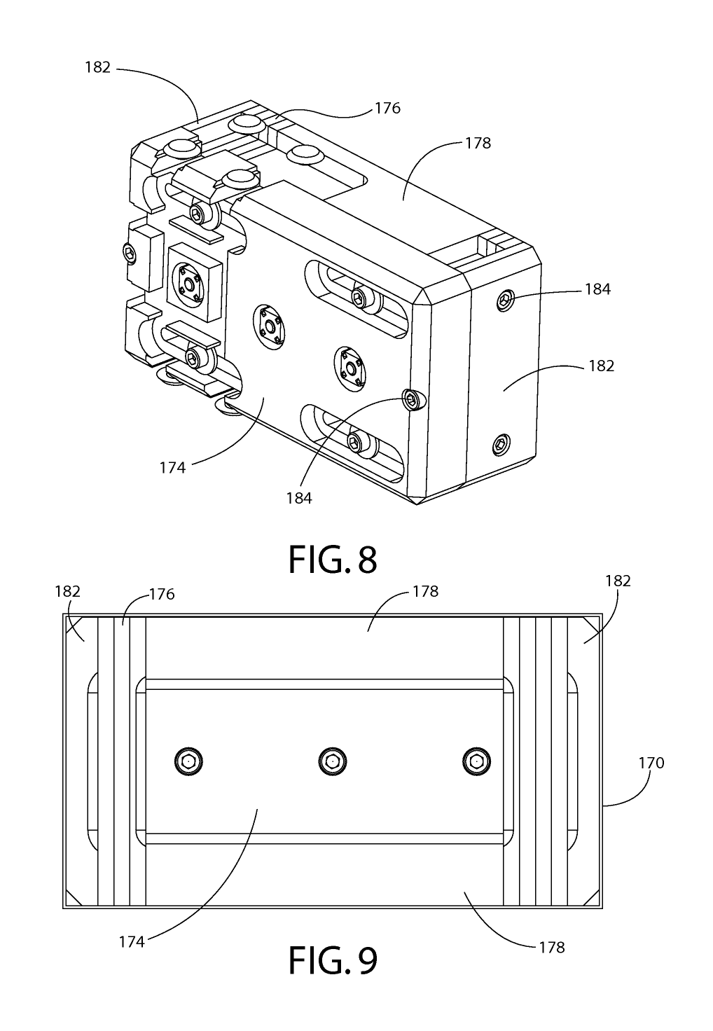

FIG. 8 is a perspective view of a partially assembled butt support of FIG. 7 without the outer shell;

FIG. 9 is a top view of the partially assembled butt support of FIG. 8;

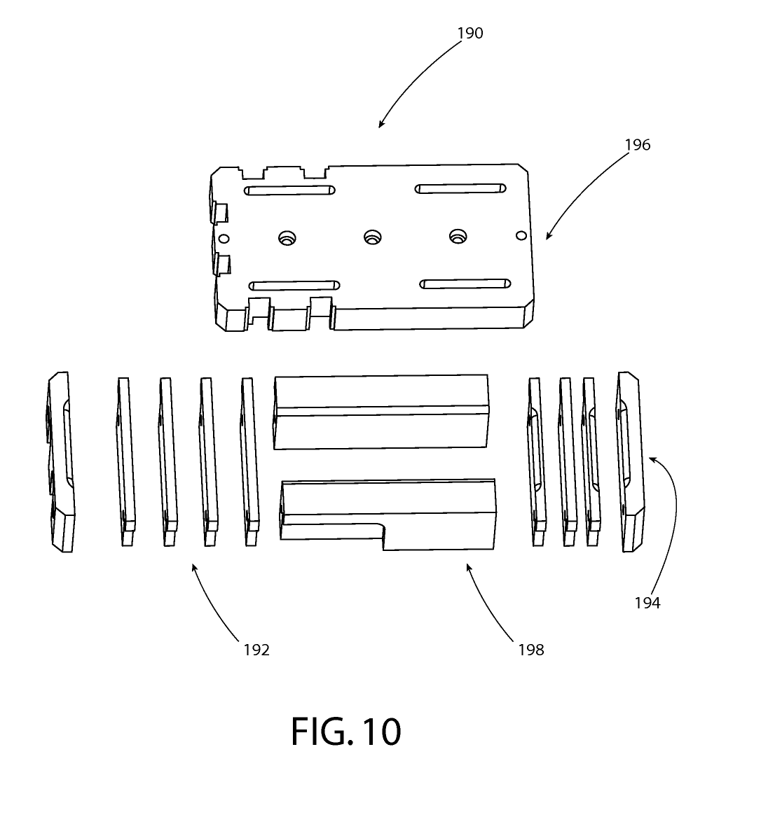

FIG. 10 is a disassembled view of a butt support having a configurable width;

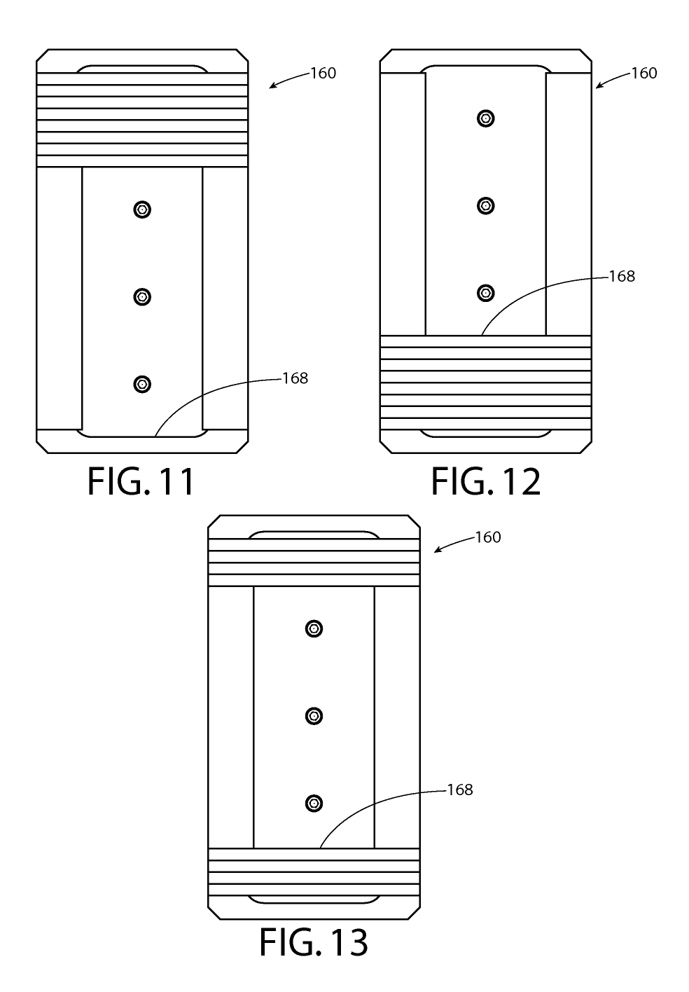

FIG. 11-13 are top views of the butt support of FIG. 6 in alternate configurations;

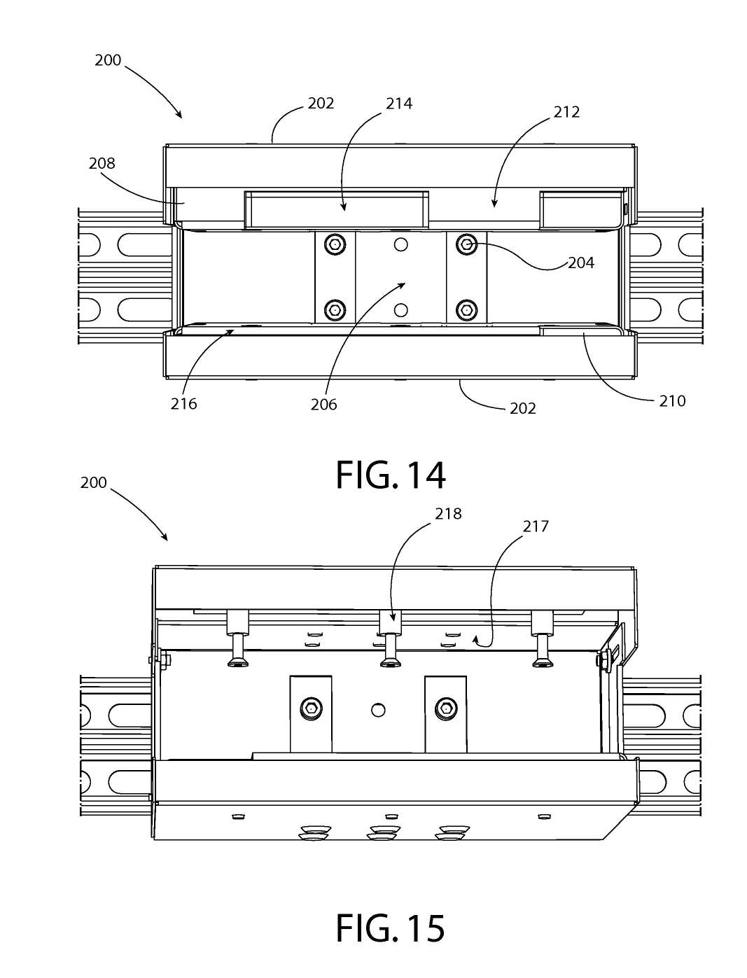

FIG. 14 is a top view of an action housing of a locking device for a firearm;

FIG. 15 is a top view of the action housing of FIG. 14 with the first profile removed;

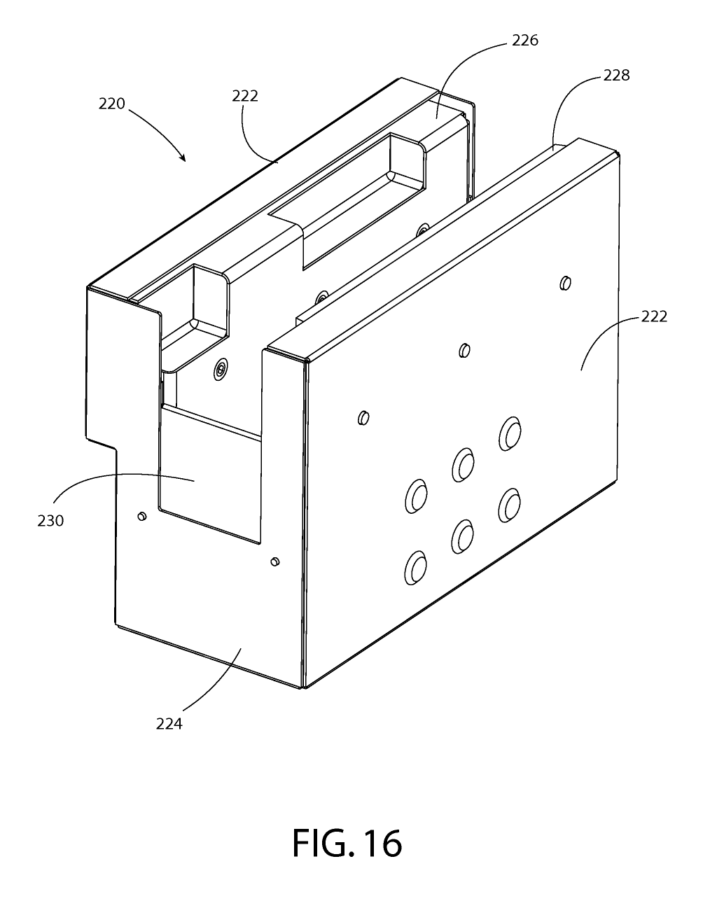

FIG. 16 is a perspective view of another embodiment of an action housing;

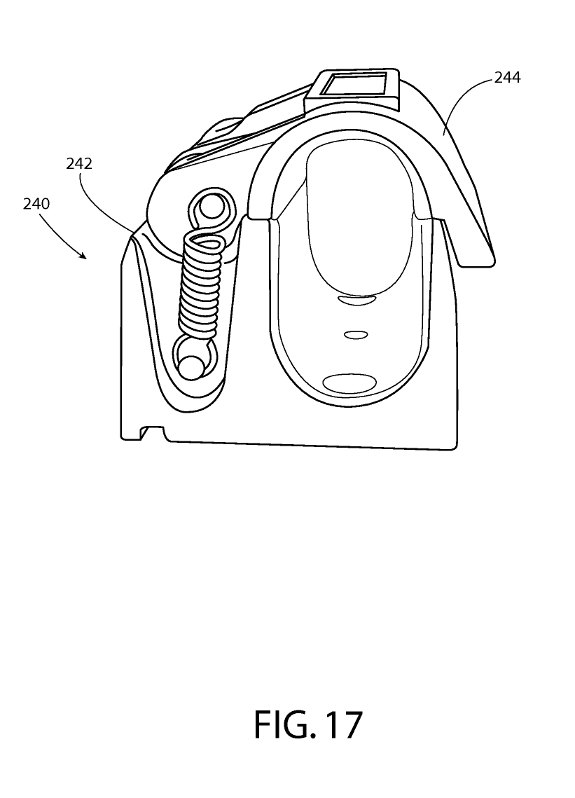

FIG. 17 is a perspective view of a barrel lock in the locked position;

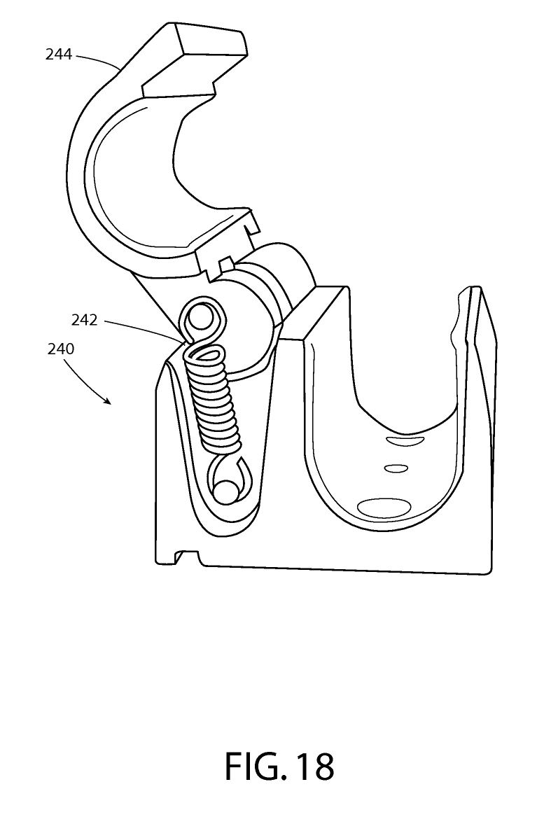

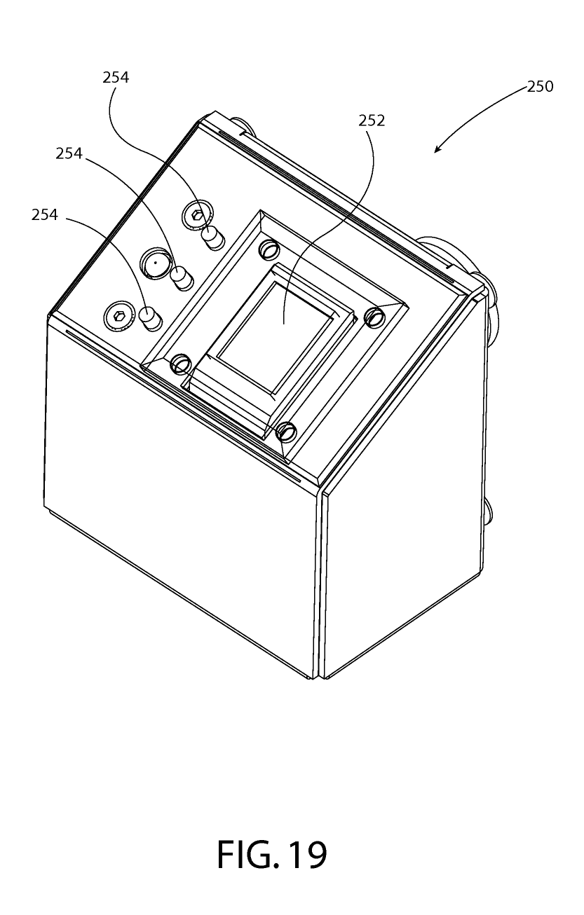

FIG. 18 is a perspective view of the barrel lock of FIG. 17 in an unlocked position;

FIG. 19 is a perspective view of a biometrically activated barrel lock;

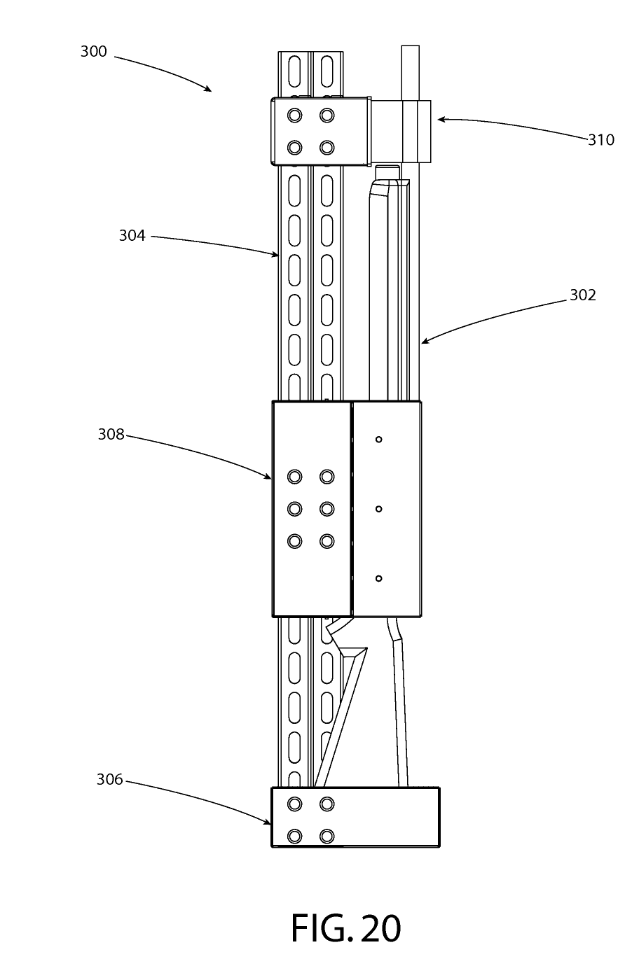

FIG. 20 is a perspective view of a locking device for a firearm in a right facing configuration; and

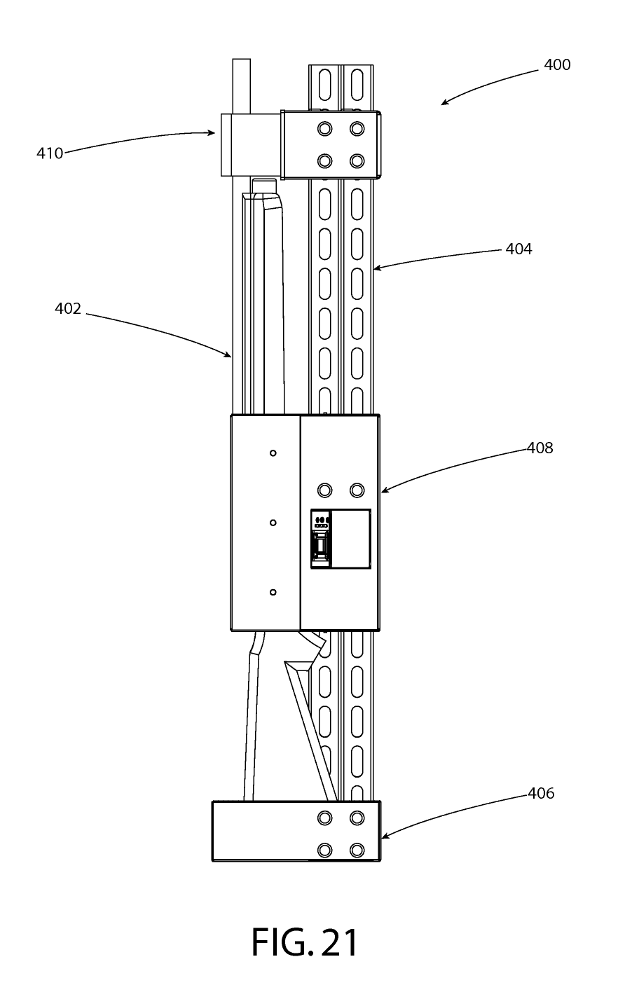

FIG. 21 is a perspective view of a locking device for a firearm in a left facing configuration.

### DETAILED DESCRIPTION

Referring generally to FIGS. 1-21 a locking device for a firearm is presently disclosed. A locking device for a firearm may be used in various embodiments to inhibit access to operable portions of the firearm such as a trigger, a magazine, ammunition, and/or a safety. More generally, the locking device may inhibit access to any component of the firearm to which access should be limited except for an authorized user. In embodiments, a locking device for a firearm may include a longitudinally extending frame that has at least one channel configured to receive a plurality of fasteners. A locking device for a firearm may also include a configurable butt support secured to the frame by at least one of the pluralities of fasteners. The butt support may further define an opening for receiving a butt of the firearm where the opening has at least one of a configurable width, a configurable length, and/or a configurable base. The locking device for a firearm may further include a configurable action housing secured to the frame by at least one of the plurality of fasteners. The action housing defines a channel between interchangeable opposing profiles where the profiles are associated with the configuration of one or more firearms and inhibit access to at least a trigger of the firearm. The locking device may further include a barrel lock secured to the frame by at least one of the plurality of fasteners. The barrel lock may be configured to secure the barrel of the firearm when in a locked position and to release the barrel of the firearm when in an unlocked position. In order to avoid unauthorized access to or use of the firearm, access to the plurality of fasteners may be inhibited when a firearm is secured in the locking device.

Referring now to FIG. 1, an embodiment of a locking device 100 for a firearm 102 is illustrated. The locking device 100 includes longitudinally extending frame 104, configurable butt support 106, configurable action housing 108, and barrel lock 110. The configurable butt support, the configurable action housing, and the barrel lock are secured to the longitudinally extending frame by a plurality of fasteners (not shown in FIG. 1). In operation, a firearm may be secured in the locking device by placing the butt of the firearm into the opening of the butt support 106, placing the action of the firearm into the action housing, and locking the barrel of the firearm with the barrel lock. In this manner, the butt support and the barrel lock cooperate to prevent removal of the firearm from the locking device when the barrel lock is in the locked position, and the action housing inhibits access to operable components of the firearm. In embodiments, the barrel lock prevents the barrel of the firearm from being removed, while the butt support restrains the butt of the firearm, securing the firearm between at least two points of connection preventing its removal. While the firearm is locked in the locking device, the configurable action housing inhibits access to operable components of the firearm such as a trigger, a magazine, ammunition, a safety, or other components appropriate to a specific type of firearm being stored in the locking device. As explained in more detail below, when the firearm is secured in the locking device, the fasteners used to connect the butt support, the action housing, and the barrel lock to the longitudinally extending frame are not accessible thereby preventing the locking device from being disassembled to gain unauthorized access to the firearm.

Referring now to FIG. 2, an example firearm is illustrated which may be used with the locking device presently disclosed. The components of the firearm are common to many firearms, however, the specific configuration, shape of the components may vary. By way of illustration, the firearm may be a long gun 120 that includes a barrel 122, an action 124, a stock 126 and a butt 128. When securing a firearm such as the firearm illustrated in FIG. 2, it may be desired to not only inhibit removal of the firearm itself, but also to inhibit access to operable components of the firearm which are predominately located in and around the action 124. Examples of components to which access may be inhibited would be a trigger, a magazine, a safety, a bolt, or a pump such as may exist on a pump-action shotgun. Inhibiting access to the operable components of the firearm reduces the risk of inadvertent firing, unauthorized access and/or unauthorized use of the firearm. In addition, it may be desired to inhibit access to removable components of the firearm, such as ammunition, in order to prevent theft or other unauthorized access to such components.

Referring now to FIG. 3, an embodiment of a longitudinally extending frame of a locking device for a firearm is illustrated. As shown in FIG. 3, the frame 140 may include a channel 142 having a plurality of fastener receptacles 144. Using the fastener receptacles, the configurable butt support, the configurable action housing, and the barrel lock may be positioned along the length of the frame at desired locations. With different configurations, lengths, and sizes of firearms, the ability to move the butt support, action housing, and barrel lock allows the locking device to be configured for each model firearm with which it may be used. In this manner, the locking device is able to accommodate a variety of firearms rather than one specific firearm as with the locking devices in the prior art. As illustrated in FIG. 3, the longitudinally extending frame includes two parallel channels 142 each channel having a plurality of fastener receptacles. The fastener receptacles 144 may be elongated slots as illustrated to provide flexibility in the specific positioning of fasteners within each channel.

In an alternative embodiment illustrated in FIG. 4, the longitudinally extending frame 150 is configured such that the plurality of fasteners are continuously adjustable within a channel along the length of the frame. As shown, the frame 150 includes channel 152. The channel extends along the length of the frame without partition or other demarcation, in contrast to the fastener receptacles illustrated in FIG. 3. By providing a continuous channel along the length of the frame, fasteners may be positioned continuously allowing greater precision in the placement of the butt support, the configurable action housing, and the barrel lock. This greater precision in placing the components of the locking device along the frame allows the locking device to more securely hold a given firearm when the locking device is configured for that specific firearm.

Referring now to FIG. 5, a cross section of the frame illustrated in FIG. 4 is shown with a fastener illustrated as a screw 156. As shown, a screw 156 may pass through channel 152 and connect to a brace 158. When the screw is tightened, the brace is drawn into contact with the interior of the frame to secure the fastener at a specific location. In some embodiments, a stop 154 (illustrated in FIG. 4) may be provided at one or both ends of the frame 150 in order to prevent fasteners from sliding out of the channel when the locking device is being configured.

Referring now to FIGS. 6-13, embodiments of a configurable butt support for use with the locking device for a firearm are illustrated. As shown in FIG. 6, a configurable butt support 160 defines an opening 162 for receiving the butt of a firearm secured in the locking device. The opening has a width 164, a length 166, and a base 168. In embodiments at least one of the width, the length, and the base of the opening are configurable such that the opening of the butt support may be configured to accommodate the butt of a specific firearm for which the locking device is to be used. The opening of the butt support defines the base 168 upon which the bottom of the butt of the firearm may rest. Due to the different shapes and configurations, particularly of the stock of firearms, it may be desirable to position to base of the opening of the butt support so that the barrel of the firearm rests substantially parallel to the longitudinally extending frame, resulting in the barrel being properly positioned to be secured in the barrel lock. As illustrated in FIG. 1, the firearm is positioned within the locking device so that the barrel of the firearm is substantially parallel to the frame allowing the barrel lock to clasp the barrel of the firearm while the butt of the firearm is firmly positioned in the butt support and the action rests securely within the action housing. In order to accommodate a variety of firearms within the configurable locking device, the butt support and specifically the opening of the butt support is configurable to assist in positioning the firearm correctly in relationship to the other components of the locking device. Moreover, the butt support inhibits movement of the butt of the firearm in both a lateral and a vertical direction relative to the frame thereby preventing the firearm from being moved once it is locked into the locking device. The butt support also prevents the firearm from being moved longitudinally to prevent the barrel of the firearm from being pulled out of the barrel lock which clasps over the barrel. In this manner, the butt support cooperates with the barrel lock to prevent the removal of the firearm from the locking device once the barrel lock is engaged in the lock position.

Referring now to FIG. 7, one embodiment of a disassembled butt support is illustrated. In an embodiment, the butt support includes an outer shell 170. The outer shell 170 may include one or more attachment points 172 through which fasteners may be placed to secure the components of the butt support together and/or to secure the butt support to the longitudinally extending frame. The butt support may also include one or more of a cap 174, spacers 176, and side bars 178, which cooperate to define the length, width, and base of the opening for the butt support. As shown in expanded view in FIG. 7, the spacers 176 may be used to adjust the position of the base of the opening relative to the frame. By disposing spacers 176 either above or below the side bars 178, the opening may be shifted within the butt support relative to the longitudinally extending frame.

In the embodiment illustrated in FIG. 7, the length and width of the butt support are fixed but the position of the base is adjustable. In other embodiments, one or more of the length and/or width of the opening are also adjustable through the use of similar spacers such as illustrated in FIG. 7 for adjusting the position of the base. In yet other embodiments, the length and width may be adjustable through the substitution of components. In one example, side bar 178 may be selected from a plurality of side bars, each of which correspond to the length of the butt of one or more firearms. In a similar manner, the side bars 178 may be provided in a variety of widths in order to adjust the width of the opening of the butt support. In yet another embodiment spacers may be provided adjacent the side bars to adjust the width of the opening of the butt support. Using a variety of spacers and selectively sized components, the opening of the butt support is configurable with respect to at least one of the length, the width or the position of the base relative to the frame. Once the components of the butt support are selected and assembled to define the opening, the components may be assembled and secured together with the use of fasteners.

As illustrated in FIG. 8, the spacers 176 and the side bars 178 are secured between opposite end caps 182 and held together with fasteners 184. In addition, the assembly is secured to a bottom cap 174 also by fasteners. The subassembly illustrated in FIG. 8 may then be placed within the outer shell 170 of the butt support as illustrated in FIG. 9. The entire butt support may then be secured to the longitudinally extending frame of the locking device. In this manner, once the butt support is assembled and secured to the frame of the locking device, the width, length, and position of the base of the opening in the butt support are fixed such that the locking device is now configured to receive the firearm for which it was configured.

Referring now to FIG. 10, another embodiment of a configurable butt support 190 is illustrated that has a configurable width. The configurable butt support 190 includes a top bar 196 and a bottom bar 198 that define the length of the opening for the butt of the firearm. The configurable width of the opening may be defined by the addition or removal of spacers 192, which are secured between opposing side caps 194. As will be apparent, various embodiments the opening in the butt support will be configurable in one or more of length, width and base in order to accommodate a variety of firearms as may be desired.

Referring now to FIGS. 11-13, a configurable butt support 160 is illustrated with three different configurations of the position of the base 168 as may be used to support different firearms in the locking device with the barrel of the firearm substantially parallel to the longitudinally expending frame.

Referring now to FIGS. 14-16, embodiments of a configurable action housing for a locking device are illustrated. The configurable action housing 200 is secured to the frame by at least one of the plurality of fasteners 204. In embodiments, the configurable action housing defines a channel 206 between interchangeable opposing profiles which are associated with the configuration of one or more firearms and inhibits access to at least a trigger of a firearm. As shown in FIG. 14, configurable action housing 200 includes a housing cover having side portions 202 that extend substantially perpendicular to the frame. The interchangeable opposing portion profiles may be disposed on interior surfaces of the side portions 202. As illustrated in FIG. 14, a first profile 208 and a second profile 210 may be secured to the side portions in order to form a channel 206 between the profiles. Each of the profiles may include one or more of a notch 212, a protrusion 214 or a contour 216 in order to substantially conform to the configuration of the action portion of a firearm to be secured in the locking device. As previously discussed, the action of a firearm may include one or more components to which access should be inhibited, and preferably prevented, in order to prevent unauthorized or undesired access to operable components of the firearm when the firearm is secured in the locking device. Because of the variations in the shapes and configurations of firearms, the action housing is configured for the specific firearm which will be secured at least in part by the selection of appropriate profiles to be installed. By way of illustration, firearms may receive or eject ammunition from the bottom, the top, or the sides of the action. The selected profiles for a given firearm would, therefore, be configured to inhibit access to the locations in which that firearm received or ejected ammunition in order to prevent access to the ammunition. While a specific profile or set of profiles may be used for each type of firearm to be stored in the locking device, in some embodiments, a profile may be configured to accommodate two or more styles of firearms if the configuration of those firearms are sufficiently similar. As an additional safety measure, it is also desired to prevent access specifically to the trigger of the firearm to limit the risk of inadvertent firing of the firearm even while stored in the locking device. In each embodiment, therefore, the profiles are configured to inhibit access to at least the trigger of the firearm. As previously noted, the profile may also prevent access to ammunition, a magazine, a safety, or other operable features on the action of the firearm.

In order to accommodate different sizes of similar style firearms, the interchangeable opposing profiles may be further adjustable within the action housing. As illustrated in FIG. 15, one or more spacers 217 may be mounted on spacer supports 218 between the side portion of the action housing and one or both of the opposing profiles. In this manner, the width of the channel may be adjustable allowing the same profile to be used for a variety of firearms having a similar configuration but different widths.

Referring now to FIG. 16, another embodiment of a configurable action housing is illustrated that has an adjustable end guard. As shown, the configurable action housing 220 includes side portions 222 surrounding a first profile 226 and a second profile 228 substantially similar to the configurable action housing illustrated in FIG. 14. In order to further limit access to the action of the firearm stored in the locking device, the configurable action housing also includes fixed end portion 224. The fixed end portion 224 may not be movable and may be permanently configured to restrict access to the interior of the configurable action housing. In some embodiments, an adjustable end guard 230 may also be provided to further close the end portion of the configurable action housing and inhibit access from the ends of the housing to the interior where the trigger of the firearm would be located. In some embodiments, the configurable end guard 230 may be integrated into one or both of the interchangeable opposing profiles. In yet other embodiments, the configurable end guard may be a separate interchangeable component that may be selected based on the firearm for which the locking device is to be configured. The locking device is therefore able to substantially limit access to the operable components of the firearm using the configurable action housing.

Referring now to FIGS. 17 and 18, an embodiment of a barrel lock for use with the presently disclosed locking device is illustrated. In one embodiment, a barrel lock 240 includes a hinge 242 and a locking clasp 244 that rotates on the hinge and at least partially surrounds the barrel of the firearm when in the locked position as illustrated in FIG. 17. When the barrel lock is in the unlocked position, however, the clasp 244 rotates to release the barrel of the firearm from the barrel lock as illustrated in FIG. 18. The locking device constrains the movement of the firearm using both the barrel lock and the butt support, eliminating the need for complex locking devices as found in many prior art devices.

Referring to FIG. 19, an embodiment of a biometrically barrel lock is illustrated. A biometric lock 250 may include a finger print reader 252 to identify a user based on a biometric feature such as a fingerprint. Although a finger print reader is illustrated, other biometric features may be used in combination with the biometric lock to identify the specific user who is authorized to access the firearm secured in the locking device. In embodiments, the biometric lock is programmable to authorize or deauthorize specific users. In one embodiment, the biometric lock may be programmed using buttons 254 provided on the biometric lock itself. In an alternative embodiment, the biometric lock may be remotely programmable allowing access to a specific locking device to be granted or restricted by a central operator. In this manner, a group of locking devices may be controlled from a central location even if the locking devices and the firearms secured therein are distributed.

In an embodiment, the biometrically activated lock 250 is a finger print reader 252 and is configured to release the barrel of the firearm when a finger print of an approved (i.e. authorized) user is presented to the biometrically activated lock. In some embodiments, it may be desired to provide improved monitoring of access to the firearm. In an embodiment, the locking device for a firearm includes a communications interface ### in communication with the biometrically activated lock 250. The communications interface may be a wired interface, such as Ethernet, or a wireless interface, such as a wifi or cellular interface. In order to monitor access to the firearm, the communications interface is configured to transmit an alert responsive to the barrel lock releasing the firearm. In one embodiment, the alert is transmitted to a user and received by the user through email on a cell phone. In an embodiment, the alert is received as a text message identifying that identifies the locking device being accessed and the identify the person whose fingerprint enabled access to the firearm. In another embodiment, the communications interface is further configured to transmit an alert responsive to detecting a fingerprint of an unapproved user presented to the biometrically activated lock. In this manner, the owner of the firearm may be informed when unauthorized users, such as children, attempt to access the firearm so that appropriate measures may be taken. In an embodiment, the alert responsive to an unauthorized user also includes an identification of the unauthorized user, such as an image of the unauthorized user's fingerprint which can be used to identify the person who attempted to access the firearm in the locking device. In yet another embodiment, the locking device includes a memory operatively connected to the biometrically activated lock which is configured to store each fingerprint presented to the biometrically activated lock. The memory may also store a time and date of each fingerprint presented thereby providing a complete audit trail of those accessing or accepting to access the firearm in the locking device.

Referring now to FIGS. 20 and 21, additional embodiments of a locking device for a firearm are illustrated in additional configurations. Prior devices used to limit access to firearms have typically been limited to securing a single model firearm in a single position or configuration. The presently disclosed locking device, however, is configurable to accommodate a plurality of firearms and also configurable to store the firearm in a variety of positions as may be desired by a given user. Using the firearm as a reference, the locking device 100 illustrated in FIG. 1 may be characterized as a center mount configuration in which the firearm is centered along the longitudinally extending frame 104. The presently disclosed locking device may alternatively be configured in a right mount configuration, as illustrated in FIG. 20. The locking device 300 includes longitudinally extending frame 304, configurable butt support 306, configurable action housing 308, and barrel lock 310. The locking device 300 is configured to secure a firearm 302 with the top of the firearm facing to the right as illustrated in FIG. 20. The configurable butt support 306, configurable action housing 308 and barrel lock are each rotated ninety degrees relative to the configuration illustrated in FIG. 1. Similarly, a locking device 400 may be provided in a left mount configuration. The locking device 400 includes longitudinally extending frame 404, configurable butt support 406, configurable action housing 408, and barrel lock 410. The locking device 400 is configured to secure a firearm 402 with the top of the firearm facing to the left as illustrated in FIG. 21. The configurable butt support 406, configurable action housing 408 and barrel lock 410 are each rotated 180 degrees relative to the corresponding components in FIG. 20 allowing the firearm to be maintained in the left facing configuration. In this manner, the configurable aspects of the locking device provide the ability to secure a variety firearms in a variety of orientations. The flexibility afforded by the presently disclosed locking device may be particularly valuable for a shooting range or gun shop that has a need to secure a variety of types of firearms while simultaneously presenting those firearms for display to potential customers.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A locking device for a firearm comprising:
a longitudinally extending frame, the frame having at least one channel configured to receive a plurality of fasteners;
a configurable butt support secured to the frame by at least one of the plurality of fasteners, the butt support defining an opening for receiving a butt of the firearm, the opening having at least one of a configurable width, a configurable length, or a configurable base;
a configurable action housing secured to the frame by at least one of the plurality of fasteners, the action housing defining a channel between interchangeable opposing profiles, wherein the profiles are associated with the configuration of one or more firearms and inhibit access to at least a trigger of the firearm; and
a barrel lock secured to the frame by at least one of the plurality of fasteners and configured to secure the barrel of the firearm when in a locked position, and to release the barrel of the firearm when in an unlocked position;
wherein when a firearm is secured in the locking device access to the plurality of fasteners is prevented.

2. The locking device for a firearm as claimed in claim 1, wherein the plurality of fasteners are continuously adjustable within the channel along a length of the frame.

3. The locking device for a firearm as claimed in claim 1, wherein the butt support is adapted to support the butt of the firearm such that the barrel of the firearm rests substantially parallel to the frame.

4. The locking device for a firearm as claimed in claim 1, wherein the opening of the butt support defines a configurable base upon which the bottom of the butt of the firearm rests, the base being at a configurable position relative to the frame corresponding to a configuration of the butt and stock of the firearm.

5. The locking device for a firearm as claimed in claim 1, wherein when the barrel lock is in a locked position, removal of the firearm from the locking device is inhibited by the lock and the butt support.

6. The locking device for a firearm as claimed in claim 1, the configurable butt support further comprising an outer shell securable to the frame and a plurality of configurable spacers disposed with the outer shell, wherein the plurality of spacers are configurable to define at least one of the width, the length and the base of the opening.

7. The locking device for a firearm as claimed in claim 1, wherein after the butt support is secured to the frame, the width, length and base of the opening are fixed.

8. The locking device for a firearm as claimed in claim 1, wherein the interchangeable opposing profiles inhibit removal of ammunition from the firearm.

9. The locking device for a firearm as claimed in claim 1, wherein the interchangeable opposing profiles are associated with the configuration of at least two firearms.

10. The locking device for a firearm as claimed in claim 1, wherein the configurable action housing further includes side portions extending perpendicular to the frame, and wherein the interchangeable opposing portions are disposed on interior surfaces of the side portions.

11. The locking device for a firearm as claimed in claim 10, wherein the interchangeable opposing portions are not removable from the housing when a firearm is secured in the locking device.

12. The locking device for a firearm as claimed in claim 1, wherein the barrel lock comprises a biometrically activated lock.

13. The locking device for a firearm as claimed in claim 13, wherein the biometrically activated lock is remotely programmable to respond to different users.

14. The locking device for a firearm as claimed in claim 13, wherein the barrel lock is configured to release the barrel of the firearm when a finger print of an approved user is presented to the biometrically activated lock.

15. The locking device for a firearm as claimed in claim 14 further comprising:
a communications interface configured to transmit an alert responsive to the barrel lock releasing the firearm.

16. The locking device for a firearm as claimed in claim 14 further comprising:
a communications interface configured to transmit an alert responsive to detecting a fingerprint of an unapproved user presented to the biometrically activated lock.

17. The locking device for a firearm as claimed in claim 14, wherein the barrel lock further includes a memory configured to store each fingerprint presented to the biometrically activated lock.
